(19) United States
(12) Patent Application Publication
(10) Pub. No.: US 2007/0202290 A1
(43) Pub. Date: Aug. 30, 2007

(54) DATA-PROTECTED DIGITAL RECORDING MEDIA

(75) Inventor: Richard H. Selinfreund, Terre Haute, IN (US)

Correspondence Address: KELLEY DRYE & WARREN LLP, 400 ATLANTIC STREET, 13TH FLOOR, STAMFORD, CT, 06901, US

(73) Assignee: Verification Technologies, Inc., Essex, CT (US)

(21) Appl. No.: 11/621,923

(22) Filed: Jan. 10, 2007

Related U.S. Application Data
(60) Provisional application No. 60/757,831, filed on Jan. 10, 2006.

(51) Int. Cl. B32B 3/02

(52) U.S. Cl. 428/64.4

(57) ABSTRACT

In one embodiment, a digital recording medium having digital datum indicia thereon readable by a reader producing a read-wave, the digital recording medium comprising: a photochromic material activatable from a first optical state to a second optical state by radiant energy having energy outside of the read-wave of the reader; and a photobleachable material activatable from a first optical state to a second optical state by radiant energy having energy within the read-wave of the reader.

### CROSS-REFERENCE TO RELATED APPLICATIONS

This application claims benefit from U.S. Provisional Patent Application Ser. No. 60/757,831, filed on Jan. 10, 2006. The disclosure of such application is hereby incorporated by reference in its entirety where appropriate for teachings of additional or alternative details, features, and/or technical background, and priority is asserted from each.

### BACKGROUND OF THE INVENTION

All references cited in this specification, and their references, are incorporated by reference herein where appropriate for teachings of additional or alternative details, features, and/or technical background.

1. Field of the Invention

The present invention generally relates to a composition for application to a recording medium, such as a digital recording medium, and in particular to an optical disc, formulated to interfere with read of the medium until the composition is appropriately activated.

2. Description of the Related Art

The development of software and other forms of content data, such as visual and auditory digital data, represents a large investment in time and money. Such content data is often stored in digital form on a transportable storage medium which is then sold to a purchaser. Unfortunately, with most traditional transportable digital recording media, clandestine movement from of the recording medium from its intended distribution path is relatively easy (particularly with transportable recording media), as is extraction of the data from the transportable storage media. Furthermore, the production of illicit copies of copyrighted material stored on recording medium is relatively simplistic even for the relatively uninitiated in computer science.

To offset the losses occurring in a transportable storage medium distribution chain, as well as illicit copying of information stored on the transportable recording medium, purveyors charge higher prices to retailers. In a similar fashion, to offset the costs of shoplifting of transportable recording medium, retailers pass charge customers higher retail prices. In the end, consumers pay considerably higher prices for recording medium due to such illicit activities.

There have been numerous attempts to curb content data piracy on transportable digital recording media. In one approach, a serial number is placed in the content data to allow for tracing of unauthorized copies of the serialized content data. The problem with this method is that it requires the task of external enforcement to track down illegal copies and is of relatively little use when the item is not associable with a particular person. Further, hackers of a number of such systems have found it relatively easy to locate and erase the serial numbers.

To deter shoplifting and distribution chain theft, some entities employ electronic article surveillance (EAS) systems that include transponder tags (RFID, etc.) attached to each article of merchandise. With respect to transportable digital recording media, such transponder tags are typically associated with the packaging surrounding the media. HAS systems further include one or more electronic readers positioned at exits to detect the transponder tags. When an item is purchased, or is removed from the distribution chain in an authorized manner, the transponder tag is disabled or removed from the article and the merchandise may pass by the reader without sounding an alarm. When a person attempts to remove an article without authorization, the reader detects the transponder tag that has not been disabled or removed from the article and sounds the alarm.

As transportable digital recording media is often small and easily concealed, EAS systems are easily overcome by simply removing the desired recording medium from its packaging, concealing the medium and then removing the medium. After the medium is removed, the data thereon can generally be copied easily. Placing RFID directly on the digital recording medium has been ruled out for several reasons, including the cost of the recording medium, the difficulty in placing the RFID in a manner to provide a read through a package, and the radio frequencies employed by such systems not being approved for in-flight use.

Theft may also occur when the purveyor of merchandise allows customers or distributors to freely return merchandise even in the absence of proof of purchase, if the merchandise being returned is carried by the sales outlet. Some persons purchase merchandise at reduced sale prices, or pilfer such merchandise, and then return the merchandise to the same or another purveyor for exchange or refund, claiming to have paid full price for the merchandise. In respect of digital recording media, a request for a refund may come after the content of the digital recording medium has been downloaded. If the purveyor refunds the full price, the purveyor loses the amount in excess of the purchase price in addition to the cost of processing the returned merchandise.

Another problem associated with software, whether licitly obtained or illicitly obtained, is that software may be easy to copy and reproduce using easily available technology. Digital data medium have in particular improved the economics of the pirate, and in some media, such a video and audio, have permitted significantly better pirated copies to be sold to the general public than permitted with other data storage media. Media distributors report the loss of billions of dollars of potential sales due to high quality copies. Such copies may be made by extracting logic data form the optical medium and then mastering new copies. For example, pirates sometimes use CD and DVD recordable medium duplicator equipment to make copies of a distributed medium, with the duplicated copies being solid directly, or used as pre-masters. Hundreds of thousands of pirated optical media may be pressed from a single master with little degradation in the quality of information stored.

Numerous patent applications assigned to Verification Technologies, and others, disclose methods for preventing copying of data from data storage media. For example, WO 02/03386 A2 discloses methods for preventing copying of data from an optical storage medium by detecting optical disuniformities or changes on the disc, and/or changes in readout signal upon re-reading of a particular area on the optical storage medium, in particular those caused by light-sensitive materials, such as dyes, which may affect the beam. Software control may be used to deny access to content if the dis-uniformity or change in read signal is not detected at the position on the disc wherein the dis-uniformity or change is anticipated.

There is a need for improved anti-theft/anti-copy recording medium systems, particularly for digital recording medium.

### Definitions

“Compound”: A substance whose molecules consist of unlike atoms and whose constituents can not be separated by physical means.

“Digital Datum Indicia”: an indicium or indicia on a Digital Recording Medium corresponding to a digital data read. Such indicia include optical pits and lands on an optical recording medium, electromagnetically altered portions on a floppy drive, recording dyes altered for digital read, punctuate indicia representative of a digital data read.

“Digital Reader”: any device capable of detecting and reading digital information that has been recorded on an Digital Recording Medium. By the term “reader” it is meant to include, without limitation, a player. Examples are CD and DVD readers.

“Digital Recording Medium”: a medium of any geometric shape (not necessarily circular) that is capable of storing information in digital form thereon. Digital Recording Medium includes, without limitation, CD, DVDs, HD-DVDs, electromagnetic tape and disks, flash drives and Optical Medium. Information stored on the medium may include, without limitation, software programs, software data, sensory files, audio files and video files.

“Light-Activated State-Change Material”: a State-Change Material that alters a measurable parameter upon application of a wavelength, or subwavelength, of light or application of photonic energy to the material.

“Material”: substance(s) or composition(s) of substances. By “Material” it is meant to include Compound(s).

“Optical Medium”: a medium of any geometric shape (not necessarily circular) that is capable of storing indicia or content that may be read by an optical reader.

“Optical Reader”: a Reader (as defined below) for the reading of Optical Medium.

“Photobleachable Compound”: a compound that upon exposure to light decreases in absorbance intensity or emission intensity;

“Photochromic Compound”: a compound that changes from one color state to another color state with different absorption spectra upon exposure to radiant energy. The effect may be reversible or irreversible.

“Permanent State-Change” material or compound: a State-Change material or compound that once activated to change a measurable parameter upon application of energy to the material or compound, stays in such state permanently or for a prolonged period of time.

“State-Change” material or compound: a material or compound capable of altering a measurable property of the material or compound upon activation of the compound by application of energy to the material or compound. “State-Change” material or compound is meant to include, without limitation, materials or compounds that change in optical state (e.g., opacity and/or color) upon application of energy to the compounds, compounds that change in electromagnetic state (e.g., electroconductive state) upon application of energy to the materials or compounds, and materials or compounds that change in physical state (e.g. crystalline to non-crystalline structure, compounds that shrink upon application of heat) upon application of energy to the material or compound.

“Temporary State-Change” material or compound: a State-Change material or compound that, once activated to change a measurable property of the material or compound upon application of energy to the compound, stays in such state for a period of time less than a year.

“Transient State-Change” compound: a State-Change material or compound that, once activated to change a measurable property of the material or compound, spontaneously in a short period of time (minutes or less), loses such change in the measurable property. It includes, without limitation, materials or compounds that move from a first state to a second state upon application of energy, and back to the first state without application of energy.

“Transportable Recording Medium”: a relatively small medium capable of being transported by hand from one location to another. It includes, without limitation, Transportable Digital Recording Medium such as an optical disc a floppy disk, a flash drive.

For the purpose of the rest of the disclosure, it is understood that the terms as defined above are intended, whether such terms are in initial cap or not.

### SUMMARY OF THE INVENTION

In an embodiment, there is disclosed a composition for effectuating an anti-theft/anti-copy recording medium (such as a digital recording medium, a transportable recording medium, an optical medium) comprising photochromic compounds, such as UV photochromic compound(s) or non-IR photochromic compound(s). Such composition may optionally include a with photobleachable compound, such as a photobleachable IR dye, and optionally one or more electron donor material, such as bis-tris. Non-IR or UV photochromic compound(s) may, in one embodiment, be used to effectuate an anti-theft modality. In such embodiment, the photochromic compound(s) may be associated with the data indicia on the medium in a manner to block read of the data indicia when it is in its nascent state. The photochromic compound(s) may be selected to effectuate a change from a colored state which obscures data read to a translucent state which permits data read through the material. Alternatively, the photochromic compound(s) may be selected to such that upon activation they move from a nascent non-colored, or nascent first-color, to a UV-activated second color. In one case wherein the photochromic compound(s) is selected such, the nascent non-colored, or nascent first-color, may possess properties (e.g. opacity, fluorescence, phosphorescence, etc.) which interfere with data read, while the UV-activated second color state is unstable, allowing the activated compound to degrade to degradation products which no longer obscure the data read by the reader. The photochromic material may be an irreversible photochromic material allowing, for example, a chemical change from an opaque to a translucent state to be maintained after removal of the UV radiation. The photochromic material may also be a reversible photochromic material, allowing for reversion to a nascent state after activation, with the nascent state being selected to block read and reverted nascent state being inactivated over a period of time (after activation) to allow read.

The recording medium may also include other wavelength-activatable materials. For example, photochromic compound(s) may be present with photobeachable compounds. The photobleachable compounds may be used, for example, to effectuate an anti-copy function, as described, for example, in U.S. Patent Publication 20040152017. The photobleaching may be caused for example by photoreduction. Photoreduction rate and/or efficiency may be improved by incorporating an electron donor material (=electrontransfer agent). The photobleaching, and its reversion to the non-photobleach state, may be used to effectuate problems in the copying function of many digital data copying protocols which reexamine data retrieved from a medium to confirm correct copying of the same, and are designed to resample if the data retrieved at one point in time matches the data retrieved at another point in time. That is, if the photobleachable compounds are placed in a manner to alter the data read at a particular position at the medium depending on whether the photobleachable compound is in a first state versus a second state, then the such copying functions are interfered with, causing the copying to be aborted. As also described in U.S. Patent Publication 20040152017, software and/or hardware control (e.g., deriving from software on the medium, or software associated with the reader or ancillary device employed in the reading process, or hardware associated with the medium itself or the reader) may be used to deny access to content if the dis-uniformity or change in read signal is not detected at the position on the disc wherein the dis-uniformity or change is anticipated by the software algorithm, as similarly disclosed in WO 02/03386 A2. Of course, the anti-copy function, may also be effectuated through the photochromic material as well, without resort to a separate photobleach material.

In another embodiment, there is disclosed a composition comprising one photochromic material which is activated at a wavelength of the reader beam of the media reader, and one photochromic material which is activated at a wavelength of other than those produced by the reader beam. The first photochromic material may be activated with a wavelength outside of the reader beam wavelengths to effectuate a desired change to allow the disc to be readable (e.g., unblocking a block in read caused by the unactivated photobleached material by bleaching to a state which allows the medium to be read) thereby overcoming the anti-theft protection. The second photochromic material may be activatable by a wavelength of the reader beam, changing to a revertible second. The second photochromic material may be selected and operatively placed to a change in read of the data indicia underlying or associated with the second photochromic material, and/or the change in state which is detectable by a software and/or hardware component designed to prohibit copying if such change is not detected. In such case the second photochromic material provides anti-copy protection after the anti-theft protection has been removed. Thus the anti-theft protection may be removed at a point in the distribution chain, for example at retail or movement to an end user, while still allowing the medium to have anti-copy protection, protecting against illicit copies of the legitimately distributed medium after authorized distribution.

Either or both of the photochromic material(s) and the photobleach material(s) may be associated in a composition containing agents that promote either or both of the activation from the first state to the second state, and/or from the second state to the first state. For example, electron transfer agents (“ETAs”) or electron donor agent (“ED”) may be used to aid in photoreduction in a photobleach reaction by providing electrons to the to the photobleachable compound that is being reduced, for example, to a corresponding leuco form or other spectrum absorbing form. Non-limiting examples of ETAs which may be incorporated into the dye system include triethanol amine, diethanol amine, TMG, DMEA, DEMEA, TMED, EDTA, Bis-Tris, p-tolylimido diethanol, N-tert-butyldiethanol amine, 4-morpholine ethanol, 1,4-bis-2-hydroxyethyl piperazine, bicine, BES, 3-Pyrrolidino-1,2-propanediol, 1-Amino-3,3-diethoxypropane, (S)-3-tert-Butylamino-1,2-propanediol, DL-Isoproterenol sulfate dihydrate, N,N-Bis(2-hydroxyethyl)-3-methoxyaniline, 1,1′-[[3-(Dimethylamino)propyl]imino]bis-2-propanol, Triethanolamine Ethoxylate, 2,2′-(4-Methylphenylimino)diethanol, Tri isopropanolamine, 2-[[2-[2-(dimethylamino)ethoxy]ethyl]methylamino]ethanol, Triethanolamine Hydrochloride, N-phenyldiethanolamine, 1-[N,N-Bis(2-hydroxyethyl)amino]-2-propanol, N-t-Butyldiethanolamine, N-Butyldiethanolamine, 3-Morpholino-1,2-propanediol, N,N-Bis(2-hydroxyethyl)ethylenediamine, 3-(Diethylamino)-1,2-propane-diol-, 4-(3-hydroxypropyl)morpholine, N-Ethyldiethanolamine, 4-(2-Hydroxyethyl)-morpholine, N-Methyldiethanolamine, 3-morpholino-1,2-propanediol, 3-diisopropyl-amino-1,2-propanediol, 3-(dimethylamino)-1,2-propanediol, 3-piperidino-1,2-propanediol, 3-(diethylamino)-1,2-propanediol, dropropizine. The ETA may be incorporated into the polymeric base of a dye system physically or chemically. For example, a useful ETA may be bound to the repeating polymeric unit.

In another embodiment, there is disclosed the a composition for effectuating an anti-theft/anti-copy disc comprising substituted and unsubstituted spiro[benzopyran-indole]compounds in conjunction with one or more electron donors, such as bis-tris. By “electron donor” it is meant a chemical entity that donates electrons to another compound. An electron donor is typically a reducing agent that, by virtue of its donating electrons, is itself oxidized in the process. Substitutions may include, for example, a halogen, NO₂, linear or branched C₁-C₆ alkyl, C₂-C₆ alkenyl, or C₃-C₆ alkynyl, C₄-C₁₀ (cycloalkyl)alkyl or (cycloalkenyl)alkyl, (cycloheteryl)alkyl, (cycloaryl)alkyl, or a substituted or unsubstituted carbocycle ring fused to a ring of the spiro[benzopyran-indole], for example, a C₃-C₁₀ cycloalkyl or cycloalkenyl, cycloheteryl, cycloaryl, and to none or another of such rings. The composition may further comprise a photobleachable IR dye, such as, for example, KF 1166 from Honeywell (Morristown, N.J.).

In another embodiment, there is disclosed a composition for effectuating an anti-theft/anti-copy disc comprising substituted and unsubstituted trimethylspiro[benzopyran-indole] compounds used in conjunction with one or more electron donors, such as bis-tris. Substitutions may include, for example, a halogen, NO2, linear or branched C₁-C₃ alkyl, C₂-C₃ alkenyl, or C₃-alkynyl, C₄-C₁₀ (cycloalkyl)alkyl or (cycloalkenyl)alkyl, (cycloheteryl)alkyl, (cycloaryl)alkyl, or a substituted or unsubstituted carbocycle ring fused to a ring of the spiro[benzopyran-indole], for example, a C₃-C₁₀ cycloalkyl or cycloalkenyl, cycloheteryl, cycloaryl, and to none or another of such rings. In another embodiment, there is disclosed a composition for effectuating an anti-theft/anti-copy disc comprising substituted and unsubstituted 1′,3′,3′-trimethylspiro[benzopyran-indole] compounds used in conjunction with one or more electron donors, such as bis-tris. Substitutions may include, for example, a halogen, NO2, linear or branched C₁-C₃ alkyl, C₂-C₃ alkenyl, or C₃-alkynyl, C₄-C₁₀ (cycloalkyl)alkyl or (cycloalkenyl)alkyl, (cycloheteryl)alkyl, (cycloaryl)alkyl, or a substituted or unsubstituted carbocycle ring fused to a ring of the spiro[benzopyran-indole], for example, a C₃-C₁₀ cycloalkyl or cycloalkenyl, cycloheteryl, cycloaryl, and to none or another of such rings. The composition may further comprise a photobleachable IR dye, such as, for example, KF 1166 from Honeywell (Morristown, N.J.).

In yet another embodiment, there is disclosed a composition for effectuating an anti-theft/anti-copy disc comprising one or more electron donors, such as bis-tris, and a compound selected from the group consisting of: 1′,3′-dihydro-1′,3′,3′-trimethyl-6-nitrospiro[2H-1-benzopyran-2,2′-(2H)-indole]; 1,3-dihydro-1,3,3-trimethyl-spiro[2H-indole-2,3′-[3H]naphth[2,1-b][1,4]oxazine]; spiro[2H-indole-2,2′-[2H]phen-anthro[9,10-b](1,4)oxazine], 5-chloro-1,3-dihydro-1,3,3-trimethyl-(9Cl); 6,8-dibromo-1′,3′-dihydro-1′,3′,3′-trimethylspiro[2H-1-benzopyran-2,2′-(2H)-indole]; and 1′,3′-dihydro-8-methoxy-1′,3′,3′-trimethyl-6-nitrospiro[2H-1-benzopyran-2,2′-(2H)-indole]. The composition may further comprise a photobleachable IR dye, such as, for example, KF 1166 from Honeywell (Morristown, N.J.).

Compositions of the present invention may further comprise monomers and polymers such as monomers and polymers of hydroxyethyl methacrylate (HEMA), and/or alcohols such as methoxy propanol.

In one embodiment, there is disclosed an optical medium having digital datum indicia thereon readable by an optical reader producing a read-wave, the optical medium comprising: a photochromic material activatable from a first optical state to a second optical state by radiant energy having energy outside of the read-wave of the optical reader; and a photobleachable material activatable from a first optical state to a second optical state by radiant energy having energy within the read-wave of the optical reader. The optical medium may further comprise at least one electron transfer agent. At least one electron transfer agent may be selected from the group comprising:
triethanol amine, diethanol amine, TMG, DMEA, DEMEA, TMED, EDTA, bis-tris, p-tolylimido diethanol, N-tert-butyldiethanol amine, 4-morpholine ethanol, 1,4-bis-2-hydroxyethyl piperazine, bicine, BES, 3-Pyrrolidino-1,2-propanediol, 1-Amino-3,3-diethoxypropane, (S)-3-tert-Butylamino-1,2-propanediol, DL-Isoproterenol sulfate dihydrate, N,N-bis(2-hydroxyethyl)-3-methoxyaniline, 1,1′-[[3-(dimethylamino)propyl]imino]bis-2-propanol, triethanolamine ethoxylate, 2,2′-(4-methylphenylimino)diethanol, triisopropanolamine, 2-[[2-[2-(dimethylamino)ethoxy]ethyl]methylamino]ethanol, triethanolamine hydrochloride, N-phenyldiethanolamine, 1-[N,N-bis(2-hydroxyethyl)amino]-2-propanol, N-t-butyldiethanolamine, N-butyldiethanolamine, 3-morpholino-1,2-propanediol, N,N-bis(2-hydroxyethyl)ethylenediamine, 3-(Diethylamino)-1,2-propane-diol-4-(3-hydroxypropyl)morpholine, N-ethyldiethanolamine, 4-(2-hydroxyethyl)-morpholine, N-methyldiethanolamine, 3-morpholino-1,2-propanediol, 3-diisopropyl-amino-1,2-propanediol, 3-(dimethylamino)-1,2-propanediol, 3-piperidino-1,2-propanediol, 3-(diethylamino)-1,2-propanediol, dropropizine; or a combination thereof.
   The at least one electron transfer agent may be associated with a polymer. The photobleachable material may be an IR-activatable photobleachable material, and photochromic material an UV-activatable photochromic material. The photochromic material may be a compound of formula 1: 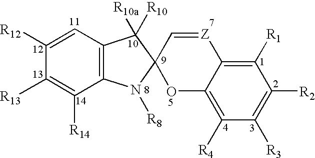
   wherein R₁, R₂, R₃, R₄, R₈, R₁₀, R₁₀ₐ, R₁₁, R₁₃, and R₁₄ are independently selected from the group of: a hydride, OH, Cl, F, Br, I, CN, NO₂, and a linear or branched C₁-C₆ alkyl, C₂-C₆ alkenyl, or C₃-C₆ alkynyl, C₄-C₁₀ (cycloalkyl)alkyl or (cycloalkenyl)alkyl, (cycloheteryl)alkyl, (cycloaryl)alkyl; and wherein R₂ and R₃, R₃ and R₄, R₁ and R₂ independently may from a ring respectively with each other, such ring which may be substituted with a moiety selected from the group of: a hydride, OH, Cl, F, Br, I, CN, NO₂, and a linear or branched C₁-C₆ alkyl, C₂-C₆ alkenyl, or C₃-C₆ alkynyl, C₄-C₁₀ (cycloalkyl)alkyl or (cycloalkenyl)alkyl, (cycloheteryl)alkyl, (cycloaryl)alkyl; and Z is C or a heteroatom selected from N, O and S. In one selection, R₁₀ and R₁₀ₐ are both methyl. In another selection, R₈ is also methyl. More over the photochromic material may be a compound selected from at least one of the group comprising:
1′,3′-dihydro-1′,3′,3′-trimethyl-6-nitrospiro[2H-1-benzopyran-2,2′-(2H)-indole]; 1,3-dihydro-1,3,3-trimethyl-spiro[2H-indole-2,3′-[3H]naphth[2,1-b][1,4]oxazine; spiro[2H-indole-2,2′-[2H]phen-anthro[9,10-b](1,4)oxazine], 5-chloro-1,3-dihydro-1,3,3-trimethyl-(9Cl); 6,8-dibromo-1′,3′-dihydro-1′,3′,3′-trimethylspiro[2H-1-benzopyran-2,2′-(2H)-indole]; and 1′,3′-dihydro-8-methoxy-1′,3′,3′-trimethyl-6-nitrospiro[2H-1-benzopyran-2,2′-(2H)-indole].
   The photobleachable material may be, for example, KF 1166.

In one aspect of such an embodiment, the optical density of is above 0.5 absorbance units at about 650 nm and 780 nm when the photochromic material(s) and photobleachable material(s) are in their nascent, unactivated, state, and below 0.2 absorbance units at about 650 nm and 780 nm when both of the photochromic material(s) and photobleachable material(s) are in their activated states. In another aspect of such embodiment, the optical density is above 0.5 absorbance units at about 405 nm, 650 nm and 780 nm when the photochromic material(s) and photobleachable material(s) are in their nascent, unactivated, state, and below 0.2 absorbance units at about 405 nm, 650 nm n and 780 nm when either of the photochromic material(s) and photobleachable material(s) are in their activated states. In another aspect of such an embodiment, the optical density is above 0.5 absorbance units at about 405 nm, 650 nm and 780 nm when the photochromic material(s) and photobleachable material(s) are in their nascent, unactivated, state, and below 0.2 absorbance units at about 405 nm, 650 nm and 780 nm when both of the photochromic material(s) and photobleachable material(s) are in their activated states.

In above embodiments, the photochromic material(s) and/or photobleachable material(s) may further comprise a polymer, such as a hydroxyethyl polymer—e.g., HEMA. Other compounds such as an alcohol, e.g., methoxy propanol, may be included.

In yet another embodiment, there is disclosed a digital recording medium having digital datum indicia thereon readable by reader producing a read-wave, the digital recording medium comprising: a spiro[benzopyran-indole] compound activatable from a first optical state to a second optical state by wavelength of light outside the read wavelengths of the reader; and a photobleachable material activatable from a first optical state to a second optical state by wavelength of light within the read wavelengths of the reader.

### DETAILED DESCRIPTION OF THE INVENTION

In one embodiment, there is disclosed system for reducing supply chain theft comprising a medium having at least one state-change material, such as a light-activated state-change material, associated therewith that is activatable from a first detectable state to a second detectable state by an activating wave that is energetically different from the read-wave of the reader, and/or that is energetically distinguishable from the read-wave of the reader. The state-change material is applied in a manner to block read by a reader of the medium until activated to the second detectable state. The state-change material may be a permanent state change material allowing for permanent read after activation, or a temporary state-change material that allows only for temporary periods of read after activation. In one possible aspect, the state-change material is a photochromic compound(s) and/or a photobleachable compound(s).

In another embodiment, there is disclosed system for reducing copying of a medium after authorized distribution having at least one state-change material, such as a light-activated state-change material associated therewith that is activatable from a first detectable state to a second detectable state by an activating wave that is energetically similar or identical to a read-wave of the reader. The state-change material is applied in a manner to block copying by a reader of the medium unless the material responds to activation by a read-wave of a reader. Block of copying may be, for example, by interfering with the copying protocol (such as causing a change in data read upon re-check of an initial data copy read causing the copy algorithms associated with the copying device to jettison the data, or to prohibit copying due to a presumed data read error) or by means of software and/or hardware associated with the medium being read, and/or the hardware used to read and copy the medium, that prohibits read of any copy that is made of the medium by the copying device that does not have appropriate characteristics associated with the state-change material (e.g., a data transition with respect to a transient state-change material which should be associated with the medium if the state-change material is located on the medium is not there, or an anticipated effect on data read (such as a change in speed of read is not there, where if the state-change material was there, would be anticipated to be seen), and/or have the state-change material not positioned in one or more locations where it should be located on the medium. In one permutation, algorithms associated with the medium (and/or the reader of the medium) may require identification of an activated permanent state change material at one or more locations on the medium to allow for copying of the medium, or read of the medium (or portion thereof). In another permutation, algorithms associated with the medium (and/or reader of the medium) may require the presence of a transient or temporary state-change material to allow for copying of the medium, or read of the medium (or portion thereof. In one possible aspect, the state-change material is a photochromic compound(s) and/or a photobleachable compound(s).

In an embodiment, there is disclosed a composition for effectuating an anti-theft/anti-copy recording medium, such as a transportable recording medium, comprising at least one photochromic compound that is activatable outside of the read beam wavelengths of a reader designed for medium reading, e.g., a UV photochromic compound(s) or a non-IR photochromic compound(s), and/or at least one photobleachable compound that is activatable in a wavelength of the read beam wavelengths of a reader designed for reading of the medium, for example, a photobleachable IR dye. Optionally included in such composition may be one or more electron donor material, such as bis-tris, to aid in photobleaching, for example.

Photochromic compound(s) may, in one embodiment, be used to effectuate an anti-theft modality. For example, non-IR or UV photochromic materials may be useful in effectuating an anti-theft modality when incorporated onto a medium that is designed for read by an interrogation beam that interrogates in the infrared spectrum. In such embodiment, the photochromic compound(s) are used to block read, e.g., by interfering with data necessary for access of content data on the medium, and/or the content data on the medium. In one anti-theft aspect, the photochromic material may be selected and associated with the data indicia, such as the digital datum indicia, on the medium in a manner to block or obscure data read of the data indicia (e.g., digital datum indicia) when the photochromic material is in its nascent state, but not to block read when it is in its photoactivated state. For example, the photochromic compound(s) may be selected to effectuate a change from a colored state which obscures data read to a translucent state upon exposure to an activatable wavelength for the change, thereby permitting data read through the material. Alternatively, the photochromic compound(s) may be selected such that upon activation they move from a nascent non-colored state, or nascent first-color state, to an activated second color state. In one case wherein the photochromic compound(s) is so selected, the nascent non-colored, or nascent first-color, may possess properties (e.g. opacity, fluorescence, phosphorescence, etc.) which interfere with data read, while the activated second color state is unstable, allowing the activated compound to degrade to degradation products which no longer obscure the data read by the reader, such as a digital reader.

Photochromic materials that may find employment in the compositions of the present invention may be an irreversible photochromic material allowing, for example, a chemical change from an opaque to a translucent state to be maintained after removal of the photoactivation emission, e.g., UV radiation. They may also be an reversible photochromic material, allowing for reversion to a nascent state after activation. In an anti-theft, or anti-piracy, application using reversible photochromic material, the material may be selected to have a nascent state that blocks read, while the reverted nascent state is degraded over a period of time (after activation) to allow read.

In one embodiment of the present invention, the medium may comprise an UV photochromic material or compound in conjunction with a photobleachable IR material or compound, with either or both acting to effectuate anti-theft or anti-copy protection. The medium may also comprise an electron donor, such as bis tris, or other agent, which may act to aid in an optical state change upon exposing the UV photochromic material or compound to a UV activating source and/or the photobleaching of the photobleachable JR material or compound upon exposure to an IR activating source, and/or the re-conversion of the activated optical state to the unactivated state of either, or both of, the photobleachable IR material or compound and the UV photochromic material or compound. In one aspect, the UV photochromic material or compound acts to prevent theft from the distribution chain by requiring the photochromic material or compound to be UV activated in order for data on the medium to be read, and the photobleachable IR material or compound acts to prevent unauthorized copying after the anti-theft protection has been removed (by activation of the UV photochromic material or compound), by interfering with the copy protocol of the medium due to IR activation of the photobleachable IR material or compound due to exposure to the interrogation beam of the medium reader, e.g. digital reader or optical reader, or by providing a marker needed by software and/or hardware associated with the medium or read of the medium in order to permit reading and/or copying of the medium. Such marker may consist, for example, as a measurable property related to the activated photobleachable IR material or compound, the nascent photobleachable IR material or compound, the transition characteristics between the nascent photobleachable IR material or compound state and the activated photobleachable IR material or compound state, a change in data read caused by the transition between the nascent photobleachable IR material or compound state and the activated photobleachable IR material or compound state, a change in read parameters due to the change from nascent photobleachable IR material or compound state to the activated photobleachable IR material or compound state.

A medium in one embodiment of the present invention comprises a spiro[benzopyran-indole] compound. The spiro[benzopyran-indole] compound(s) may include substitutions which may include, for example, a hydride, a halogen, NO₂, linear or branched C₁-C₆ alkyl, C₂-C₆ alkenyl, or C₃-C₆ alkynyl, C₄-C₁₀ (cycloalkyl)alkyl or (cycloalkenyl)alkyl, (cycloheteryl)alkyl, (cycloaryl)alkyl, or a substituted or unsubstituted carbocycle ring fused to a ring of the spiro[benzopyran-indole], for example, a C₃-C₁₀ cycloalkyl or cycloalkenyl, cycloheteryl, cycloaryl, other rings fused to such rings. The spiro[benzopyran-indole] compound may be found in conjunction with a photobleachable IR dye, such as KF 1166 from Honeywell (Morristown, N.J.).

In one embodiment the spiro[benzopyran-indole] compound is at least one of a compound of the formula 1: 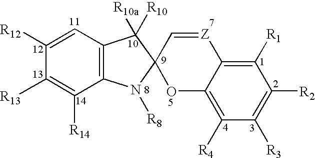
wherein R₁, R₂, R₃, R₄, R₈, R₁₀, R₁₀ₐ, R₁₁, R₁₃, and R₁₄ are independently selected from the group of: a hydride, OH, Cl, F, Br, I, CN, NO₂, and a linear or branched C₁-C₆ alkyl, C₂-C₆ alkenyl, or C₃-C₆ alkynyl, C₄-C₁₀ (cycloalkyl)alkyl or (cycloalkenyl)alkyl, (cycloheteryl)alkyl, (cycloaryl)alkyl; and R₂ and R₃, R₃ and R₄, R₁ and R₂ independently may from a ring respectively with each other, such ring which may be substituted with a moiety selected from the group of: a hydride, OH, Cl, F, Br, I, CN, NO₂, and a linear or branched C₁-C₆ alkyl, C₂-C₆ alkenyl, or C₃-C₆ alkynyl, C₄-C₁₀ (cycloalkyl)alkyl or (cycloalkenyl)alkyl, (cycloheteryl)alkyl, (cycloaryl)alkyl. In an embodiment, R₁₀ and R₁₀ₐ are both methyl. Optionally, R₈ may also be methyl. In an embodiment, Z is C or a heteroatom selected from N, O, and S.

In yet another embodiment, there is disclosed a composition for effectuating an anti-theft/anti-copy recording medium a compound selected from the group consisting of: 1′,3′-dihydro-1′,3′,3′-trimethyl-6-nitrospiro[2H-1-benzopyran-2,2′-(2H)-indole]; 1,3-dihydro-1,3,3-trimethyl-spiro[2H-indole-2,3′-[3H] naphth[2,1-b][1,4]oxazine]; spiro[2H-indole-2,2′-[2H]phen-anthro[9,10-b](1,4)oxazine), 5-chloro-1,3-dihydro-1,3,3-trimethyl-(9Cl); 6,8-dibromo-1′,3′-dihydro-1′,3′,3′-trimethylspiro[2H-1-benzopyran-2,2′-(2H)-indole]; and 1′,3′-dihydro-8-methoxy-1′,3′,3′-trimethyl-6-nitrospiro[2H-1-benzopyran-2,2′-(2H)-indole]. Such composition may further comprise a photobleachable IR dye. The composition may further comprise one or more electron donors, such as bis-tris.

There is also disclosed an anti-theft/anti-copy mixture for application to an recording medium, such as an optical disc, comprising a polymer or monomer, such as HEMA or other hydroxyethyl containing a polymer or monomer, an alcohol, such as, for example, methoxy propanol, an electron donor such as his tris, and a UV photochromic dye selected from at least one from the group consisting of:

### 1′, 3′-Dihydro-1′,3′,3′-trimethyl-6-nitrospiro[2H-1-benzopyran-2,2′-(2H)-indole]

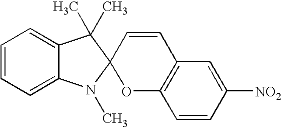

### 1,3-Dihydro-1,3,3-trimethylspiro[2H-indole-2,3′-[3H]naphth[2,1-b][1,4]oxazine]

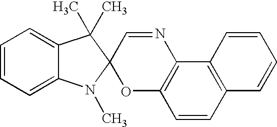

### Spiro[2H-indole-2,2′-[2H]phenanthro[9,10-b](1,4)oxazine], 5-chloro-1,3-dihydro-1,3,3-trimethyl-(9Cl)

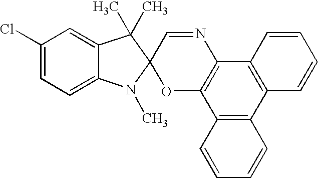

### 6,8-Dibromo-1′,3′-dihydro-1′,3′,3′-trimethylspiro[2H-1-benzopyran-2,2′-(2-indole]

97%

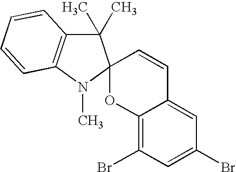

### 1,3′-Dihydro-8-methoxy-1′,3′,3′-trimethyl-6-nitrospiro[2H-1-benzopyran-2,2′-(2H)-indole]

97% 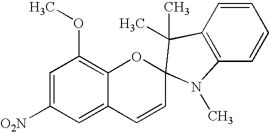
Optionally a photobleachable IR dye. The mixture may provide for theft protection in requiring activation of the dye substance to allow for read of data associated with the disc and/or copy-protection by software detection of an optical change in the material and/or by causing a change in data read by a reader, such as a digital reader/optical reader, which is detectable, as discussed above.

### EXAMPLE 1

30-300 mls of HEMA, for example, 72.8. However, the HEMA may be removed with a coating solution replacing same;

10-500 mls of methoxy propanol, for example, 194 mls;

7.5 grams of his tris (for the electron donor); however, the electron donor could come from a oligomer with free hydroxyl groups if the dye system is mixed into the coating solution.

1.75 grams of one of the dyes listed immediately (UV component); and

1.75 grams of the photo dye KF 1166 from Honeywell (Morristown, N.J.) or another photobleachable IR dye.

When a UV photochromic dye and a photobleachable JR dye are combined, with or without the electron donor (such as bis-tris), the optical density of the combined dyes may advantageously be ˜1.0 absorbance units (“AU”) at 650 nm and 780 nm and/or 405 nm. However, any absorbance unit above 0.5 AU may provide advantageous results in blocking read of the data on an optical recording medium, such as a digital recording medium, when the dye is associated with particular data indicia on the medium. After photobleach, the absorbance at 405 nm, 650 nm and 780 nm may advantageously be below 0.2 AU. However, below 0.5 AU is payable on most players.

### Statement Regarding Preferred Embodiments

While the invention has been described with respect to preferred embodiments, those skilled in the art will readily appreciate that various changes and/or modifications can be made to the invention without departing from the spirit or scope of the invention as defined by the appended claims.

What is claimed:

1. An optical medium having digital datum indicia thereon readable by an optical reader producing a read-wave, said optical medium comprising:
a photochromic material activatable from a first optical state to a second optical state by radiant energy having energy outside of the read-wave of said optical reader; and
a photobleachable material activatable from a first optical state to a second optical state by radiant energy having energy within the read-wave of said optical reader.

2. An optical medium in accordance with claim 1 further comprising at least one electron transfer agent.

3. An optical medium in accordance with claim 2 wherein at least one electron transfer agent is selected from group comprising:
triethanol amine, diethanol amine, TMG, DMEA, DEMEA, TMED, EDTA, bis-tris, p-tolylimido diethanol, N-tert-butyldiethanol amine, 4-morpholine ethanol, 1,4-bis-2-hydroxyethyl piperazine, bicine, BES, 3-Pyrrolidino-1,2-propanediol, 1-Amino-3,3-diethoxypropane, (S)-3-tert-Butylamino-1,2-propanediol, DL-Isoproterenol sulfate dihydrate, N,N-bis(2-hydroxyethyl)-3-methoxyaniline, 1,1′-[[3-(dimethylamino)propyl]imino]bis-2-propanol, triethanolamine ethoxylate, 2,2′-(4-methylphenylimino)diethanol, triisopropanolamine, 2-[[2-[2-(dimethylamino)ethoxy]ethyl]methylamino]ethanol, triethanolamine hydrochloride, N-phenyldiethanolamine, 1-[N,N-bis(2-hydroxyethyl)amino]-2-propanol, N-t-butyldiethanolamine, N-butyldiethanolamine, 3-morpholino-1,2-propanediol, N,N-bis(2-hydroxyethyl)ethylenediamine, 3-(Diethylamino)-1,2-propane-diol-, 4-(3-hydroxypropyl)morpholine, N-ethyldiethanolamine, 4-(2-hydroxyethyl)-morpholine, N-methyldiethanolamine, 3-morpholino-1,2-propanediol, 3-diisopropyl-amino-1,2-propanediol, 3-(dimethylamino)-1,2-propanediol, 3-piperidino-1,2-propanediol, 3-(diethylamino)-1,2-propanediol, dropropizine:
or combination thereof.

4. An optical medium in accordance with claim 2 wherein at least one electron transfer agent is associated with a polymer.

5. An optical medium in accordance with claim 2 wherein the photobleachable material is an IR-activatable photobleachable material.

6. An optical medium in accordance with claim 1 wherein the photochromic material is an UV-activatable photochromic material.

7. An optical medium in accordance with claim 1 wherein the photochromic material is a compound of formula 1: 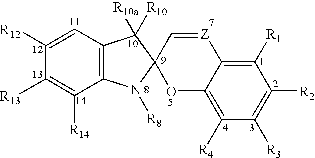
wherein R₁, R₂, R₃, R₄, R₈, R₁₀, R₁₀ₐ, R₁₁, R₁₃, and R₁₄ are independently selected from the group of: a hydride, OH, Cl, F, Br, I, CN, NO₂, and a linear or branched C₁-C₆ alkyl, C₂-C₆ alkenyl, or C₃-C₆ alkynyl, C₄-C₁₀ (cycloalkyl)alkyl or (cycloalkenyl)alkyl, (cycloheteryl)alkyl, (cycloaryl)alkyl; and wherein R₂ and R₃, R₃ and R₄, R₁ and R₂ independently may from a ring respectively with each other, such ring which may be substituted with a moiety selected from the group of a hydride, OH, Cl, F, Br, I, CN, NO₂, and a linear or branched C₁-C₆ alkyl, C₂-C₆ alkenyl, or C₃-C₆ alkynyl, C₄-C₁₀ (cycloalkyl)alkyl or (cycloalkenyl)alkyl, (cycloheteryl)alkyl, (cycloaryl)alkyl; and Z is C or a heteroatom selected from N, O and S.

8. An optical medium in accordance with claim 7, wherein R₁₀ and R₁₀ₐ are both methyl.

9. An optical medium in accordance with claim 8 wherein R₈ is methyl.

10. An optical medium in accordance with claim 1 wherein the photochromic material is a compound selected from at least one of the group comprising:
1′,3′-dihydro-1′,3′,3′-trimethyl-6-nitrospiro[2H-1-benzopyran-2,2′-(2H)-indole]; 1,3-dihydro-1,3,3-trimethyl-spiro[2H-indole-2,3′-[3 naphth[2,1-b][1,4]oxazine]; spiro[2H-indole-2,2′-[2H]phen-anthro[9,10-b](1,4)oxazine], 5-chloro-1,3-dihydro-1,3,3-trim ethyl-(9Cl); 6,8-dibromo-1′,3′-dihydro-1′,3′,3′-trimethylspiro[2H-1-benzopyran-2,2′-(2H)-indole]; and 1′,3′-dihydro-8-methoxy-1′,3′,3′-trimethyl-6-nitrospiro[2H-1-benzopyran-2,2′-(2H)-indole].

11. An optical medium in accordance with claim 1, wherein the photobleachable material is KF 1166.

12. An optical medium in accordance with claim 1 wherein the optical density is above 0.5 absorbance units at about 405 nm, 650 nm and 780 nm when the photochromic material(s) and photobleachable material(s) are in their nascent, unactivated, state, and below 0.2 absorbance units at about 405 nm, 650 nm and 780 nm when either of the photochromic material(s) and photobleachable material(s) are in their activated states.

13. An optical medium in accordance with claim 1 wherein the optical density is above 0.5 absorbance units at about 405 nm, 650 nm and 780 nm when the photochromic material(s) and photobleachable material(s) are in their nascent, unactivated, state, and below 0.2 absorbance units at about 405 nm, 650 nm and 780 nm when both of the photochromic material(s) and photobleachable material(s) are in their activated states.

14. An optical medium in accordance with claim 1 further comprising a polymer.

15. An optical medium in accordance with claim 14 wherein the polymer is a hydroxyethyl polymer.

16. An optical medium in accordance with claim 15 wherein the hydroxyethyl polymer is HEMA.

17. An optical medium in accordance with claim 14 further comprising an alcohol.

18. An optical medium in accordance with claim 17 wherein the alcohol is methoxy propranol.

19. An optical medium in accordance with claim 1 wherein the optical density is above 0.5 absorbance units at about 650 nm and 780 nm when the photochromic material(s) and photobleachable material(s) are in their nascent, unactivated, state, and below 0.2 absorbance units at about 650 nm and 780 nm when both of the photochromic material(s) and photobleachable material(s) are in their activated states.

20. An digital recording medium having digital datum indicia thereon readable by reader producing a read-wave, said digital recording medium comprising:
a spiro[benzopyran-indole] compound activatable from a first optical state to a second optical state by wavelength of light outside the read wavelengths of the reader; and
a photobleachable material activatable from a first optical state to a second optical state by wavelength of light within the read wavelengths of said reader.
